(19) United States
(12) Patent Application Publication
(10) Pub. No.: US 2005/0149736 A1
(43) Pub. Date: Jul. 7, 2005

(54) Data-security printing method and system using authentication protocol in network printer

(76) Inventor: Woo-chang Kim, Suwon-si (KR)

Correspondence Address: STANZIONE & KIM, LLP, 1740 N STREET, N.W., FIRST FLOOR, WASHINGTON, DC, 20036, US

(21) Appl. No.: 11/020,048

(22) Filed: Dec. 23, 2004

(30) Foreign Application Priority Data
Jan. 2, 2004 (KR) 2004-54

(51) Int. Cl. H04L 9/00

(52) U.S. Cl. 713/177

(57) ABSTRACT

A data-security printing method and a data-security printing system capable of preventing one-way encryption cracking (Brute-Force Attack), by randomly specifying a port to transmit printer data between a printer driver and a firmware using an authentication protocol and then transmitting the printer data. The data-security printing system includes a terminal and a network printer, wherein the terminal transmits a protocol frame for user authentication to the network printer and transmits the data to the network printer through a temporary data path formed as a result of the user authentication, and wherein the network printer receives the protocol frame from the terminal, execute the user authentication, receives the data from the terminal through the temporary data path formed as a result of the user authentication, and prints the received data. As a result, it is possible to prevent one-way encryption cracking (Brute-Force Attack).

### CROSS-REFERENCE TO RELATED APPLICATIONS

This application claims the priority of Korean Patent Application No. 2004-54, filed on Jan. 2, 2004, in the Korean Intellectual Property Office, the disclosure of which is incorporated herein in its entirety by reference.

### BACKGROUND OF THE INVENTION

1. Field of the Invention

The present general inventive concept relates to a method and a system of generating a random port in a network printer and transmitting data, and more particularly, to a data-security printing method and a data-security printing system capable of preventing one-way encryption cracking (Brute-Force Attack) by randomly specifying a port to transmit printer data between a printer driver and a firmware using an authentication protocol and transmitting the printer data under a network environment.

2. Description of the Related Art

FIG. 1 is a block diagram illustrating a conventional security printing system, where the system comprises a terminal 100 and a network printer 110. The terminal 100 includes a data processing unit 101, a control unit 102, and a transmitting and receiving unit 103, and the network printer 110 includes an authentication processing unit & ID and password storage unit 111, a control unit 112, a transmitting and receiving unit 113, and a printing unit 114.

Referring to FIG. 1, the transmitting and receiving unit 103 transmits the same data as shown in FIG. 2 including authentication contents to the network printer 110.

The data processing unit 101 processes the printer data and the authentication contents, thereby generating transmission data.

The control unit 102 allows the data processing unit 101 to process documents prepared through application programs of the terminal 100 and to transmit the documents to the transmitting and receiving unit 103.

On the other hand, in the network printer 110, the transmitting and receiving unit 113 receives the transmission data including the authentication contents from the terminal 100.

The authentication processing unit & ID and password storage unit 111 extracts the authentication contents from the transmission data received from the terminal 100, compares the authentication contents with the stored ID and password, and transmits the authentication result to the control unit 102.

The control unit 112 receives the authentication result from the authentication processing unit & ID and password storage unit 111, determines whether the printing of the transmission data should be executed, and transmits data to be printed to the printing unit 114 or abolishes the transmission data in accordance with the authentication result.

The printing unit 114 receives the data to be printed from the control unit 112, converts the data into binary data, and prints the data.

FIG. 2 is a diagram illustrating a conventional security printing data format, where the data format comprises an IP header portion including a destination IP and printer data. In the meantime, the printer data has a header portion including a user ID and a password processed with a printer job language (PJL) and a main portion including the data to be printed.

The network printer 110 extracts the user ID and password from the header portion of the printer data shown in FIG. 2, compares the user ID and password from the header portion with the user ID and password stored in the authentication processing unit & ID and password storage unit 111 of the network printer 110, and determines whether both correspond with each other.

In the conventional security printing system as described above, the user ID and password may be stolen through one-way encryption cracking (Brute-Force Attack) and may also be exposed to denial-of-service attacks.

### SUMMARY OF THE INVENTION

The present general inventive concept provides a data-security printing method and a data-security printing system capable of preventing one-way encryption cracking (Brute-Force Attack) by randomly specifying a port to transmit printer data between a printer driver and a firmware using an authentication protocol and transmitting the printer data only when a printer is used.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a data-security printing system using an authentication protocol, the system comprising a terminal to transmit data to be printed to a network printer through a temporary data path formed using the authentication protocol and the network printer, wherein the terminal transmits a protocol frame for user authentication to the network printer and transmits the data to the network printer through the temporary data path formed as a result of the user authentication, and wherein the network printer receives the protocol frame from the terminal, executes the user authentication, receives the data from the terminal through the temporary data path formed as a result of the user authentication, and prints the received data.

The terminal may comprise: an encryption processing unit that generates an encryption code obtained by encrypting a user ID and a password using a predetermined method for the user authentication; an authentication protocol processing unit that transmits the protocol frame including the encryption code to the network printer; a data transmitting unit that transmits the data to the network printer through the temporary data path formed as a result of the user authentication; and a control unit that controls all the units.

The control unit may allow the encryption processing unit to generate the encryption code for the user authentication, allow the authentication protocol processing unit to transmit the protocol frame including the generated encryption code to the network printer, and allow the data transmitting unit to transmit the data to be printed to the network printer through the temporary data path formed as a result of the user authentication.

The network printer may comprise: an ID and password storage unit that stores a user ID and a password; an encryption processing unit that generates an encryption code obtained by encrypting the stored user ID and password using a predetermined method, executes the user authentication by comparing the generated encryption code with an encryption code extracted from the protocol frame transmitted from the terminal, and encrypts the network port for transmitting the data; an authentication protocol processing unit that receives the protocol frame from the terminal for the user authentication, transmits the protocol frame to the encryption processing unit, receives the encrypted network port from the encryption processing unit, and transmits the encrypted network port to the terminal; a data receiving unit that receives the data through the temporary data path formed as the result of the user authentication; a printing unit that converts the received data into printable data and prints the converted data; and a control unit that controls all the units.

The control unit may allow the encryption processing unit to extract the encryption code from the protocol frame received by the authentication protocol processing unit and to execute the user authentication, allow the encryption processing unit to encrypt the network port using the encryption code as an encryption key so as to form the temporary data path when the user authentication is completed, and allow the authentication protocol processing unit to transmit the encrypted network port to the terminal.

The foregoing and/or other aspects and advantages of the present general inventive concept may also be achieved by providing a network printer that receives data from a terminal through a temporary data path formed using an authentication protocol and prints the received data, the network printer comprising: an ID and password storage unit that stores a user ID and a password; an encryption processing unit that generates an encryption code obtained by encrypting the stored user ID and password using a predetermined method, executes the user authentication by comparing the generated encryption code with an encryption code extracted from the protocol frame transmitted from the terminal, and encrypts the network port to transmit the data; an authentication protocol processing unit that receives the protocol frame from the terminal for the user authentication, transmits the protocol frame to the encryption processing unit, receives the encrypted network port from the encryption processing unit, and transmits the encrypted network port to the terminal; a data receiving unit that receives the data through the temporary data path formed as the result of the user authentication; a printing unit that converts the received data into printable data and prints the converted data; and a control unit that controls all the units.

The control unit may allow the encryption processing unit to extract the encryption code from the protocol frame received by the authentication protocol processing unit and to execute the user authentication, allow the encryption processing unit to encrypt the network port using the encryption code as an encryption key so as to form the temporary data path when the user authentication is completed, and allow the authentication protocol processing unit to transmit the encrypted network port to the terminal.

The foregoing and/or other aspects and advantages of the present general inventive concept may also be achieved by providing a data-security printing method of a data-security printing system using an authentication protocol, the system comprising a terminal to transmit data to be printed to a network printer through a temporary data path formed using the authentication protocol and the network printer, the method comprising: requesting a network port to the network printer using the authentication protocol and performing user authentication so as to form the temporary data path; and transmitting data to be printed to the network printer through the formed temporary data path.

The requesting operation may comprise the operations of: determining whether a user is identified; and determining whether an encryption code is identified.

The determining operation may comprise the operations of: transmitting a first protocol frame including a user ID to the network printer; determining whether the user is identified by comparing a user ID stored in the network printer with the user ID included in the first protocol frame transmitted to the network printer; and transmitting a second protocol frame to the terminal so as to request a first encryption code, when it is determined at the operation of transmitting a second protocol frame that the user is identified.

The operation of determining whether an encryption code is identified may comprise the operations of: transmitting a third protocol frame including the first encryption code to the network printer; and transmitting a fourth protocol frame including a second encryption code obtained by encrypting the network port.

The first encryption code may be generated by performing an XOR operation of a 128-bit code obtained by processing the user ID with an MD5 algorithm and a 128-bit code obtained by processing the password with the MD5 algorithm.

The operation of transmitting a fourth protocol frame may comprise the operations of: extracting the first encryption code from the third protocol frame; determining whether the second encryption code generated using the user ID and password stored in the network printer corresponds with the first encryption code; and transmitting the fourth protocol frame including a third encryption code obtained by encrypting the network port to the terminal, when it is determined that the second encryption code corresponds with the first encryption code.

The second encryption code may be generated by performing an XOR operation of a 128-bit code obtained by processing the user ID stored in the network printer with an MD5 algorithm and a 128-bit code obtained by processing the password stored in the network printer with the MD5 algorithm.

At the operation of transmitting data to be printed to the network printer through the formed temporary data path, the data may include printer data and the printer data may include the third encryption code in a header portion thereof.

The third encryption code may be generated by encrypting the network port using the first encryption code or the second encryption code as an encryption key.

As described above, by randomly specifying a port to transmit printer data between a printer driver and a firmware using an authentication protocol and then transmitting the printer data, it is possible to prevent one-way encryption cracking (Brute-Force Attack).

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a conventional security printing system;

FIG. 2 is a diagram illustrating a conventional security printing data format;

FIG. 3 is a block diagram illustrating a security printing system according to an embodiment of the present general inventive concept;

FIG. 4 is a diagram illustrating an authentication protocol procedure according to an embodiment of the present general inventive concept;

FIG. 5 is a table illustrating protocol types according to an embodiment of the present general inventive concept;

FIG. 6 is a diagram illustrating a basic format of a protocol frame according to an embodiment of the present general inventive concept;

FIG. 7 is a diagram illustrating a network port request protocol frame (first protocol frame) according to an embodiment of the present general inventive concept;

FIG. 8 is a diagram illustrating an encryption code request protocol frame (second protocol frame) according to an embodiment of the present general inventive concept;

FIG. 9 is a diagram illustrating an encryption code transmitting protocol frame (third protocol frame) according to an embodiment of the present general inventive concept;

FIG. 10 is a diagram illustrating a network port transmitting protocol frame (fourth protocol frame) according to an embodiment of the present general inventive concept;

FIG. 11 is a diagram illustrating a method of generating an encrypted 128-bit code according to an embodiment of the present general inventive concept;

FIG. 12 is a diagram illustrating a method of encrypting and decrypting a network port according to an embodiment of the present general inventive concept;

FIG. 13 is a diagram illustrating a format of data transmitted to a network printer according to an embodiment of the present general inventive concept;

FIG. 14 is a diagram illustrating an authentication procedure according to an embodiment of the present general inventive concept;

FIG. 15 is a diagram illustrating in detail operation S100 of FIG. 14;

FIG. 16 is a diagram illustrating in detail operation S200 of FIG. 15; and

FIG. 17 is a diagram illustrating in detail operation S210 of FIG. 15.

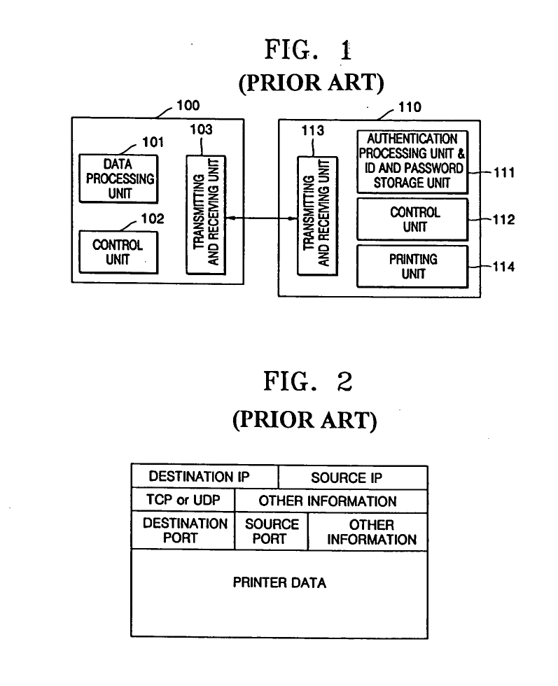

### DETAILED DESCRIPTION OF THE PREFERRED EMBODIMENTS

Hereinafter, exemplary embodiments of a data-security printing method and a data-security printing system according to the present general inventive concept will be described in detail with reference to the attached drawings. Like reference numerals in the drawings denote like elements, and thus their description will be omitted. The present general inventive concept may, however, be embodied in many different forms and should not be construed as being limited to the embodiments set forth herein; rather, these embodiments are provided so that this disclosure will be thorough and complete, and will fully convey the general inventive concept to those skilled in the art.

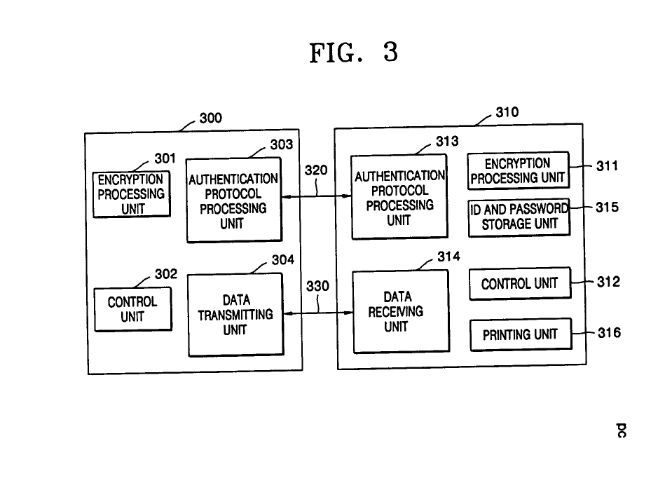

FIG. 3 is a block diagram illustrating a security printing system according to an embodiment of the present general inventive concept, where the system comprises a terminal 300 and a network printer 310. The terminal 300 includes an encryption processing unit 301, a control unit 302, an authentication protocol processing unit 303, and a data transmitting unit 304. The network printer 310 includes an encryption processing unit 311, a control unit 312, an authentication protocol processing unit 313, a data receiving unit 314, an ID and password storage unit 315, and a printing unit 316. A path 320 is always connected between the terminal 300 and the network printer 310 and indicates a permanent path to exchange authentication protocol frames for user authentication. A path 330 indicates a temporary data path (TDP) formed when transmitting data to be printed after the user authentication is completed, and the path 330 is closed when transmission of data is completed.

Referring to FIG. 3, in the terminal 300, the encryption processing unit 301 converts a user ID and a password into a 128-bit encryption code under control of the control unit 302 for the purpose of the user authentication, by using the same method as shown in FIG. 11 (to be described in detail later).

The control unit 302 allows the encryption processing unit 301 to generate an encryption code obtained by encrypting the user ID and password for the purpose of the user authentication, allows the authentication protocol processing unit 303 to transmit a protocol frame including the generated encryption code to the network printer 310, and allows the data transmitting unit 304 to transmit the data to be printed to the network printer 310 through the temporary data path 330 formed as a result of the user authentication.

The authentication protocol processing unit 303 communicates with the authentication protocol processing unit 313 of the network printer 310 and forms the temporary data path 330 through which the data to be printed are transmitted to the network printer 310.

The data transmitting unit 304 transmits the data to be actually printed to the network printer 310 through the temporary data path 330 in accordance with the user authentication.

Next, in the network printer 310, the encryption processing unit 311 reads out the user ID and password stored in the encryption processing unit 311, encrypts the user ID and password using the same method as shown in FIG. 11, and thus generates the encryption code. The encryption code generated in this way is used for authentication. That is, the encryption code is compared with the encryption code encrypted using the similar method by the terminal 300 to perform the user authentication.

The control unit 312 allows the encryption processing unit 311 to extract the encryption code from the protocol frames received by the authentication protocol processing unit 313 and to execute the user authentication, and when the user authentication is completed, allows the authentication protocol processing unit 313 to encrypt the network port using the encryption code as an encryption key to generate the temporary data path 330 and to transmit the encrypted network port to the terminal 300.

The authentication protocol processing unit 313 communicates with the authentication protocol processing unit 303 of the terminal 300 and generates the temporary data path 330 to receive the data to be printed.

The data receiving unit 314 receives the data to be actually printed from the terminal 300 through the temporary data path 330.

The ID and password storage unit 315 stores user IDs and passwords.

The printing unit 316 converts the received data into binary data under control of the control unit 312, thereby a printer engine (not shown) to print the converted data.

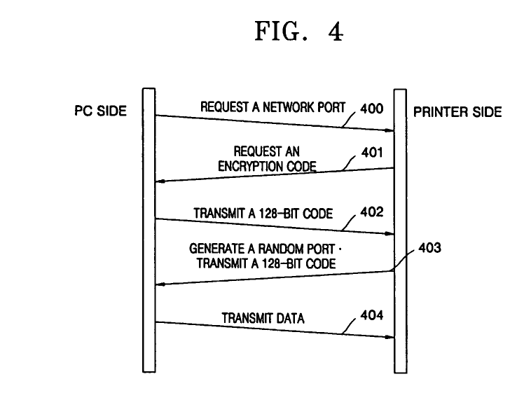

FIG. 4 is a diagram illustrating an authentication protocol procedure according to an embodiment of the present general inventive concept, where the authentication procedure shown in FIG. 4 is performed when data to be printed exists in the terminal 300.

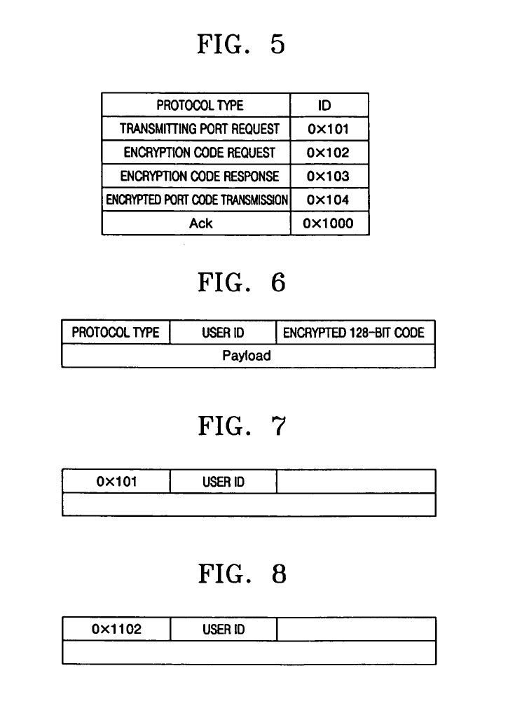

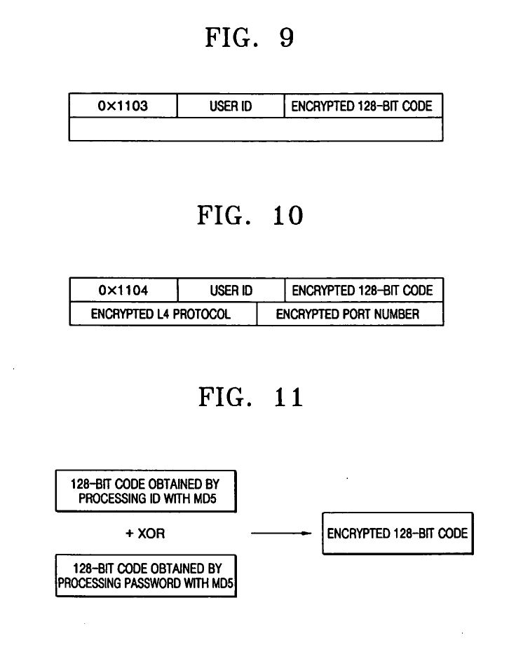

FIG. 5 is a table illustrating protocol types according to an embodiment of the present general inventive concept, FIG. 6 is a diagram illustrating a basic format of a protocol frame according to an embodiment of the present general inventive concept, FIG. 7 is a diagram illustrating a network port request protocol frame (first protocol frame) according to an embodiment of the present general inventive concept, FIG. 8 is a diagram illustrating an encryption code request protocol frame (second protocol frame) according to an embodiment of the present general inventive concept, FIG. 9 is a diagram illustrating an encryption code transmitting protocol frame (third protocol frame) according to an embodiment of the present general inventive concept, and FIG. 10 is a diagram illustrating a network port transmitting protocol frame (fourth protocol frame) according to an embodiment of the present general inventive concept.

Firstly, a basic format of the protocol frame to be exchanged for the user authentication is the same as shown in FIG. 6 and includes a protocol type, a user ID, a 128-bit encryption code, and a payload. Here, the payload refers to data to be actually transmitted.

Referring to FIGS. 4 to 10, the authentication protocol processing unit 303 requests the network port through which data can be transmitted to the network printer 310 (operation 400).

In this case, a format of the protocol frame to be transmitted to the network printer 310 is the same as shown in FIG. 7 and includes ID 0X101 indicating the transmission port request and the user ID.

That is, referring to the table of FIG. 5, the control unit 302 fills the protocol type and the user ID and allows the authentication protocol processing unit 303 to transmit the protocol frame to the network printer 310.

When the network printer 310 receives the same protocol frame as shown in FIG. 7, the encryption processing unit 311 determines whether there exists a user ID in the ID and password storage unit 315 at a first authentication step. When it is determined that there exists the user ID, the protocol frame requesting the same encryption code as shown in FIG. 8 is transmitted to the terminal 300 (operation 401). The protocol type shown in FIG. 8 is generated with reference to the table shown in FIG. 5 by performing an OR operation of 0X1000 as an Ack type and 0X102 as an encryption code request ID. When it is determined that the user ID does not exist in the ID and password storage unit 315, the network printer does not open the network port.

When the terminal 300 receives an encryption code request protocol frame shown in FIG. 8, the encryption processing unit 301 encrypts the user ID and password using the same method as shown in FIG. 11 under control of the control unit 302. The protocol frame of which the 128-bit encryption code is filled is shown in FIG. 9. The protocol type shown in FIG. 9 is generated by performing an OR operation of 0X1000 as an Ack type and 0X104 as an encryption code response with reference to the table shown in FIG. 5, and the user ID and the 128-bit encryption code are added thereto and then transmitted.

When the network printer 310 receives the protocol frame shown in FIG. 9, the encryption processing unit 311 generates a 128-bit encryption code from the user ID and password stored in the ID and password storage unit 315 using the same method as shown in FIG. 11 under control of the control unit 312. The generated 128-bit encryption code is compared with the 128-bit encryption code transmitted from the terminal 300 and the user authentication is performed.

As a result of the user authentication, when the two encryption codes do not correspond with each other, a protocol session is closed and initialized. However, when the two encryption codes correspond with each other and the user authentication is passed, a port (UDP port or TCP port) is randomly generated, the formed network port is encrypted, and the same protocol frame as shown in FIG. 10 is transmitted to the terminal 300.

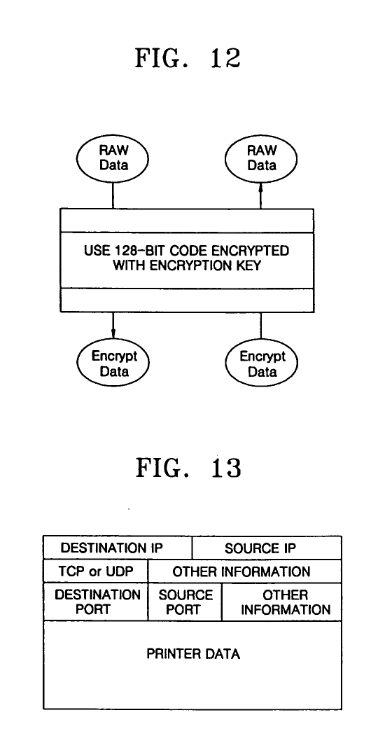

When the terminal 300 receives the protocol frame shown in FIG. 10, as shown in FIG. 12, the network port is decrypted, and the data shown in FIG. 13 are transmitted to the network printer 310 through the decrypted network port.

FIG. 11 is a diagram illustrating a method of generating a 128-bit encryption code encrypted for the user authentication according to an embodiment of the present general inventive concept, where the 128-bit encryption code for the user authentication is generated by processing the user ID and password using a message digest 5 (MD5) method to generate the 128-bit codes an then performing an XOR operation on the 128-bit codes.

FIG. 12 is a diagram illustrating a method of encrypting and decrypting the network port according to an embodiment of the present general inventive concept, which means encrypting raw data as the network port into encrypted data or decrypting vice versa. Here, the

FIG. 13 is a diagram illustrating a format of data to be transmitted to the network printer according to an embodiment of the present general inventive concept, where the data format comprises a header such as a destination IP, a source IP, a TCP or UDP, a destination port, and a source port and printer data. In the printer data, the user ID and password encrypted are described in the header portion thereof with a printer job language, and the data to be actually printed is included in the main portion thereof. According to an embodiment of the present general inventive concept, the 128-bit encryption code encrypted using the method shown in FIG. 11 is included in the header portion of the printer data.

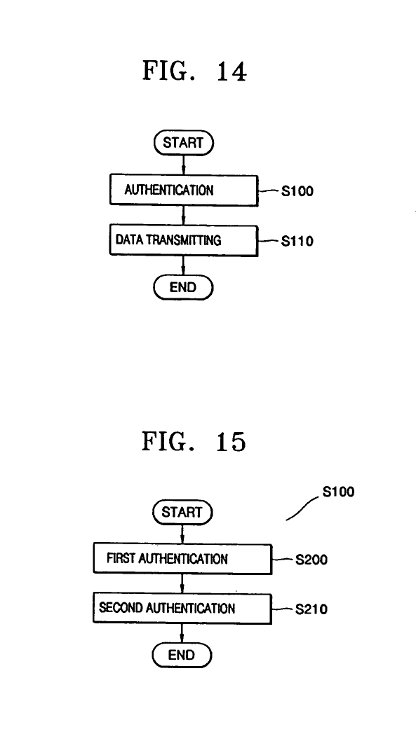

FIG. 14 is a diagram illustrating an authentication procedure according to an embodiment of the present general inventive concept, where the authentication procedure comprises an authentication operation S100 and a data transmitting operation S110. Referring to FIG. 14, at the authentication operation S100, the protocol frames are exchanged between the terminal 300 and the network printer 310 for the user authentication, and at the data transmitting operation S110, the transmission data shown in FIG. 13 are transmitted to the network printer 310 from the terminal 300 through the temporary data path formed when the user authentication is passed at the operation S100 and are printed on a printing paper.

FIG. 15 is a diagram illustrating in detail the operation S100 of FIG. 14, where the operation S100 comprises a first authentication operation S200 and a second authentication operation S210.

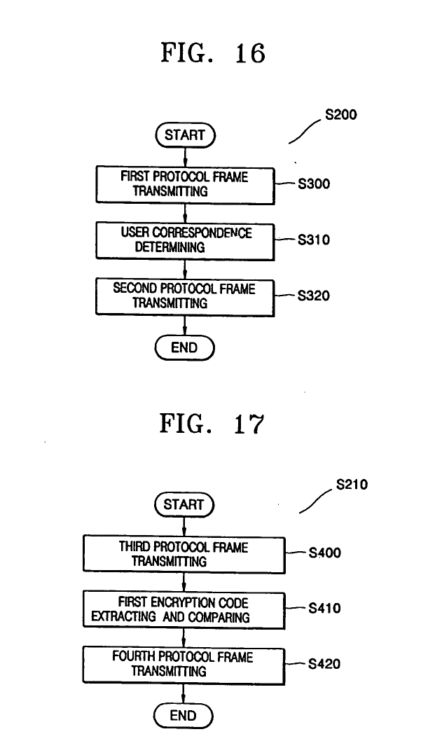

At the first authentication operation S200, the first authentication using the user ID is performed. FIG. 16 is a diagram illustrating in detail the operation S200 of FIG. 15, where the operation S200 comprises a first protocol frame transmitting operation S300, a user correspondence determining operation S310, and a second protocol frame transmitting operation S320.

The first authentication operation S200 will be described with reference to FIG. 16.

At the first protocol frame transmitting operation S300, the protocol frame including the user ID shown in FIG. 7 is transmitted to the network printer 310 through a permanent path (PP) 320.

At the user correspondence determining operation S310, the first authentication procedure is performed by searching the ID and password storage unit 315 and determining whether the user ID is included in the protocol frame shown in FIG. 7.

At the second protocol frame transmitting operation S320, when the user authentication at step 310 is passed, the protocol frame requesting the encryption code shown in FIG. 8 is transmitted to the terminal 300.

At the second authentication operation S210, the second authentication using the user ID and password is performed. FIG. 17 is a diagram illustrating in detail the operation S210 of FIG. 15, where the operation S210 comprises a third protocol frame transmitting operation S400, a first encryption code extracting and comparing operation S410, and a fourth protocol transmitting operation S420.

At the third protocol frame transmitting operation S400, the protocol frame shown in FIG. 9 is transmitted to the network printer 310 through the permanent path (PP) 320.

At the first encryption code extracting and comparing operation S410, the first encryption code, that is, the encrypted 128-bit code, is extracted from the third protocol frame. Further, the user ID and password stored in the ID and password storage unit 315 are encrypted using the method shown in FIG. 11 and thus the 128-bit code is generated. The second authentication procedure is performed by comparing the two codes.

At the fourth protocol transmitting operation S420, when the second authentication at step S410 is passed, the network port is encrypted as shown in FIG. 12, and the encrypted network port is transmitted to the terminal 300 together with the encrypted 128-bit code.

The terminal 300 having received the fourth protocol frame decrypts the encrypted network port using the 128-bit encryption code as an encryption key as shown in FIG. 12 and transmits the data shown in FIG. 13 through the network port.

The data received by the network printer 310 are converted into binary data by the printing unit 316 and then are printed on a printing sheet through the printer engine.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A data-security printing system using an authentication protocol, the system comprising a terminal to transmit data to be printed to a network printer through a temporary data path formed using the authentication protocol and the network printer,
wherein the terminal transmits a protocol frame for user authentication to the network printer and transmits the data to the network printer through the temporary data path formed as a result of the user authentication; and
wherein the network printer receives the protocol frame from the terminal, executes the user authentication, receives the data from the terminal through the temporary data path formed as a result of the user authentication, and prints the received data.

2. The data-security printing system according to claim 1, wherein the terminal comprises:
an encryption processing unit that generates an encryption code obtained by encrypting a user ID and a password using a predetermined method for the user authentication;
an authentication protocol processing unit that transmits the protocol frame including the encryption code to the network printer;
a data transmitting unit that transmits the data to the network printer through the temporary data path formed as a result of the user authentication; and
a control unit that controls all the terminal units.

3. The data-security printing system according to claim 2, wherein the control unit allows the encryption processing unit to generate the encryption code for the user authentication, allows the authentication protocol processing unit to transmit the protocol frame including the generated encryption code to the network printer, and allows the data transmitting unit to transmit the data to be printed to the network printer through the temporary data path formed as a result of the user authentication.

4. The data-security printing system according to claim 1, wherein the network printer comprises:
an ID and password storage unit that stores a user ID and a password;
an encryption processing unit that generates an encryption code obtained by encrypting the stored user ID and password using a predetermined method, executes the user authentication by comparing the generated encryption code with an encryption code extracted from the protocol frame transmitted from the terminal, and encrypts a network port to transmit the data;
an authentication protocol processing unit that receives the protocol frame from the terminal for the user authentication, transmits the protocol frame to the encryption processing unit, receives the encrypted network port from the encryption processing unit, and transmits the encrypted network port to the terminal;
a data receiving unit that receives the data through the temporary data path formed as the result of the user authentication;
a printing unit that converts the received data into printable data and prints the converted data; and
a control unit that controls all the units.

5. The data-security printing system according to claim 4, wherein the control unit allows the encryption processing unit to extract the encryption code from the protocol frame received by the authentication protocol processing unit and to execute the user authentication, allows the encryption processing unit to encrypt the network port using the encryption code as an encryption key so as to form the temporary data path when the user authentication is completed, and allows the authentication protocol processing unit to transmit the encrypted network port to the terminal.

6. A network printer that receives data from a terminal through a temporary data path formed using an authentication protocol and prints the received data, the network printer comprising:
an ID and password storage unit that stores a user ID and a password;
an encryption processing unit that generates an encryption code obtained by encrypting the stored user ID and password using a predetermined method, executes the user authentication by comparing the generated encryption code with an encryption code extracted from the protocol frame transmitted from the terminal, and encrypts the network port to transmit the data;
an authentication protocol processing unit that receives the protocol frame from the terminal for the user authentication, transmits the protocol frame to the encryption processing unit, receives the encrypted network port from the encryption processing unit, and transmits the encrypted network port to the terminal;
a data receiving unit that receives the data through the temporary data path formed as the result of the user authentication;
a printing unit that converts the received data into printable data and prints the converted data; and
a control unit that controls all the units.

7. The network printer according to claim 6, wherein the control unit allows the encryption processing unit to extract the encryption code from the protocol frame received by the authentication protocol processing unit and to execute the user authentication, allows the encryption processing unit to encrypt the network port using the encryption code as an encryption key so as to form the temporary data path when the user authentication is completed, and allows the authentication protocol processing unit to transmit the encrypted network port to the terminal.

8. A data-security printing method of a data-security printing system using an authentication protocol, the system comprising a terminal to transmit data to be printed to a network printer through a temporary data path formed using the authentication protocol and the network printer, the method comprising:
requesting a network port to the network printer using the authentication protocol and performing user authentication so as to form the temporary data path; and
transmitting data to be printed to the network printer through the formed temporary data path.

9. The data-security printing method according to claim 8, wherein the requesting a comprises the operations of:
determining whether a user is identified; and
determining whether an encryption code is identified.

10. The data-security printing method according to claim 9, wherein the operation of determining whether a user is identified comprises the operations of:
transmitting a first protocol frame including a user ID to the network printer;
determining whether the user is identified by comparing a user ID stored in the network printer with the user ID included in the first protocol frame transmitted to the network printer; and
transmitting a second protocol frame to the terminal so as to request a first encryption code, when it is determined that the user is identified.

11. The data-security printing method according to claim 10, wherein the operation of determining whether an encryption code is identified comprises the operations of:
transmitting a third protocol frame including the first encryption code to the network printer; and
transmitting a fourth protocol frame including a second encryption code obtained by encrypting the network port.

12. The data-security printing method according to claim 10, wherein the first encryption code is generated by performing an XOR operation of a 128-bit code obtained by processing the user ID with an MD5 algorithm and a 128-bit code obtained by processing the password with the MD5 algorithm.

13. The data-security printing method according to claim 11, wherein operation of transmitting a fourth protocol frame comprises the operation of:
extracting the first encryption code from the third protocol frame;
determining whether the second encryption code generated using the user ID and password stored in the network printer corresponds with the first encryption code; and
transmitting the fourth protocol frame including a third encryption code obtained by encrypting the network port to the terminal, when it is determined that the second encryption code corresponds with the first encryption code.

14. The data-security printing method according to claim 13, wherein the second encryption code is generated by performing an XOR operation of a 128-bit code obtained by processing the user ID stored in the network printer with an MD5 algorithm and a 128-bit code obtained by processing the password stored in the network printer with the MD5 algorithm.

15. The data-security printing method according to claim 8, wherein at the operation of transmitting data to be printed to the network printer through the formed temporary path, the data includes printer data and the printer data includes the third encryption code in a header portion thereof.

16. The data-security printing method according to claim 13, wherein the third encryption code is generated by encrypting the network port using the first encryption code or the second encryption code as an encryption key.

17. The data-security printing method according to claim 15, wherein the third encryption code is generated by encrypting the network port using the first encryption code or the second encryption code as an encryption key.

18. A data-security printing system comprising:
a terminal to generate a protocol frame for a user authentication, transmit the generated protocol frame through a first path and transmit print data through a temporary data path formed after a user authentication is processed; and
a network printing unit to receive the protocol frame from the terminal, process the user authentication based on the received protocol frame, receive the print data through the temporary data path based on the user authentication, and to print the print data.

19. The data-security printing system according to claim 17, wherein the terminal comprises:
an encryption processing unit to generate an encryption code obtained by encrypting a user ID and a password for the user authentication;
an authentication protocol processing unit to transmit the protocol frame including the encryption code to the network printing unit; and
a data transmitting unit to transmit the print data to the network printing unit through the temporary data path formed as a result of the processed user authentication.

20. The data-security printing system according to claim 19, further comprising:
a control unit to allow the encryption processing unit to generate the encryption code obtained by encrypting the user ID and password for the purpose of the user authentication, to allow the authentication protocol processing unit to transmit a protocol frame including the generated encryption code to the network printing unit, and to allow the data transmitting unit to transmit the print data to the network printing unit through the temporary data path.

21. The data-security printing system according to claim 18, wherein the network printing unit comprises:
an ID and password storage unit to store a user ID and a password;
an encryption processing unit to generate an encryption code obtained by encrypting the stored user ID and password using a predetermined method, to execute the user authentication by comparing the generated encryption code with an encryption code extracted from the protocol frame transmitted from the terminal, and to encrypt a network port to transmit the data;
an authentication protocol processing unit to receive the protocol frame from the terminal for the user authentication, to transmit the protocol frame to the encryption processing unit, to receive the encrypted network port from the encryption processing unit, and to transmit the encrypted network port to the terminal;
a data receiving unit to receive the print data through the temporary data path formed as a result of the user authentication;
a printing unit to convert the received print data into printable data and to print the converted data.

22. The data-security printing system according to claim 21, wherein the network printing unit further comprises:
a control unit to allow the encryption processing unit to extract the encryption code from the protocol frames received by the authentication protocol processing unit and to process the user authentication, and when the user authentication process is completed, to allow the authentication protocol processing unit to encrypt the network port using the encryption code as an encryption key to generate the temporary data path and to transmit the encrypted network port to the terminal.

23. A data-security printing method of a data-security printing system comprising:
requesting a network port from a network printer using an authentication protocol and performing user authentication to form a temporary data path to transmit data to the network printer; and
transmitting the data to be printed to the network printer through the formed temporary data path.

24. The data-security printing method according to claim 23, wherein the operation of requesting a network port comprises:
determining whether a user is identified; and
determining whether an encryption code is identified.
